(19) United States
(12) Patent Application Publication
(10) Pub. No.: US 2018/0258243 A1
(43) Pub. Date: Sep. 13, 2018

(54) Composition For Adhering A Polymer To A Substrate and A Method Of Preparation Thereof

(71) Applicant: Hong Kong Applied Science and Technology Research Institute Company Limited, Shatin (HK)

(72) Inventors: Wenwei Zheng, Ma On Shan (HK); Hailong Wu, Fanling (HK); Yaofeng Sun, Tai Po (HK)

(21) Appl. No.: 15/455,208

(22) Filed: Mar. 10, 2017

(51) Int. Cl. C08J 5/12; B05D 1/18; B05D 3/00; C09J 4/06

(52) U.S. Cl. CPC C08J 5/124; B05D 1/18; C08J 2443/04; C09J 4/06; C08J 2365/04; B05D 3/007

(57) ABSTRACT

The invention provides a composition for adhering one or more polymers to a substrate. The composition comprises at least one first compound adapted to be coated on a surface of the substrate. The first compound comprises one or more first units each having at least one functional group adapted to chemically react with at least one monomer to form the one or more polymers. Said composition also comprises at least one second compound adapted to be coated on the surface of the substrate. The second compound comprising one or more second units interspersed among the one or more first units of the first compound. Each of the one or more second units is not chemically reactive to the at least one monomer. The invention also provides a method of preparing a polymer coated surface on a substrate using the composition described.

### FIELD OF THE INVENTION

The invention relates to the field of surface treatment for a substrate, particularly but not exclusively, to a composition for adhering a polymer to a substrate, and a method of preparation of such composition.

### BACKGROUND OF THE INVENTION

There has been growing interest in developing surface treatment techniques for electrical and electronic circuit applications, for example, for the purpose of providing insulation between conducting layers in through silicon vias (TSVs). In traditional TSVs, although silicon dioxides have commonly been used as insulating materials, polymer-based insulation layers have recently been found to demonstrate potential advantages of much lower required process temperature, simpler fabrication process, and lower costs than silicon dioxide-based ones.

One commonly used polymer for TSV insulation is Parylene, which is the trade name for a variety of chemical vapor deposited poly(p-xylylene) polymers. Parylene is preferred due to its relatively low cost and low processing temperature when compared with the conventional TSV insulating materials such as silicone dioxide. However, one major challenge in using polymers for TSV insulation is interfacial delamination. The occurrence of interfacial delamination, especially after circuits have been subjected to a highly accelerated stress test (HAST), which is a test widely adopted in evaluating reliability and stability in electronic components and conducted at 130° C., 85% relative humidity for 96 hours, can result in open-circuits in the electronic circuits which is highly undesirable and may even be potentially dangerous.

### OBJECTS OF THE INVENTION

An object of the present invention is to provide a novel composition for adhering a polymer to a substrate such that interfacial delamination at one or more polymer/substrate interfaces can be substantially minimized, reduced or avoided.

Another object of the present invention is to mitigate or obviate to some degree one or more problems associated with known adhesives for adhering a polymer to a substrate, particularly but not exclusively, for electrical and electronic applications.

The above objects are met by the combination of features of the main claims; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

### SUMMARY OF THE INVENTION

In general, the invention provides a composition for adhering a polymer to a substrate, and particularly, for providing and/or enhancing adhesions between a polymer and a substrate for electrical and electronic applications. For example, the composition of the present invention can be applied to adhere and/or to enhance adhesion of one or more insulating polymers, such as Parylene, with an electrically conducting surface such as, but not limited to, one or more silicon substrates of a through silicon via (TSV). The composition can be provided in the form of, for example, a layer-like structure adapted to chemically bond with a surface of the substrate. The composition comprises at least one first compound having one or more grafter units, with each of the grafters having at least one reactive functional head group adapted to chemically react with one or more monomers in forming the polymer. Particularly, the polymerization will result in one or more polymer molecules grafted at the respective grafter sites to thereby adhere the formed polymer chains at the substrate surface. More importantly, the composition also comprises at least one second compound having one or more diluter units, which are arranged to be interspersed among the one or more grafters in the layer-like structure causing a reduction and thus optimization of the grafter density at the layer-like structure. In contrast to the grafters, the diluters do not comprise reactive functional head groups for polymerization, and therefore, are not capable of chemically reacting with the monomers. No polymer chains can thus be grafted at the sites of the diluters. The invention is shown to enable improvement in or even optimization of the grafter density in the layer-like adhesive structure, and consequently, minimize, reduce or avoid chances of premature termination of the growing polymer chains due to overly high grafter density. The invention is thus capable of significantly enhancing the interfacial bonding strength between the polymer and the substrate, and is found to be effective in minimizing, reducing, or avoiding interfacial delamination under the highly accelerated stress test (HAST)

In a first main aspect, the invention provides a composition for adhering one or more polymers to a substrate. The composition comprises at least one first compound adapted to be coated on a surface of the substrate. Said first compound comprises one or more first units each having at least one functional group adapted to chemically react with at least one monomer to form the one or more polymers. The composition further comprises at least one second compound adapted to be coated on the surface of the substrate. Said second compound comprises one or more second units interspersed among the one or more first units of the first compound; wherein each of the one or more second units is not chemically reactive to the at least one monomer.

In a second main aspect, the invention provides a method of preparing a polymer coated surface on a substrate using the composition according to the first aspect. The method comprises the steps of: providing a solution having at least one first compound and at least one second compound, the at least one first compound comprising one or more first units, and the at least one second compound comprising one or more second units; treating a surface of a substrate with the solution thereby forming a treated surface bonded with the one or more first units and the one or more second units, with the one or more first units and the one or more second units being interspersed with one another; reacting the treated surface with one or more monomers thereby grafting one or more polymers only at the one or more first units, but not at the one or more second units.

In a third main aspect, the invention provides a substrate having an intermediate layer on a surface thereof for adhesion of a polymer. Said intermediate layer comprises one or more first surface bonding units interspersed with one or more second surface bonding units, wherein only the one or more first surface bonding units are capable of chemically reacting with one or more monomers to form polymers to thereby adhere the polymers at the substrate surface.

The summary of the invention does not necessarily disclose all the features essential for defining the invention; the invention may reside in a sub-combination of the disclosed features.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 is a schematic diagram showing the bonding of a grafter molecule and a diluter molecule on a surface of a substrate according to a first embodiment of the present invention;

FIG. 2 is a schematic diagram showing the grafting of polymer chains only at the grafters according to the embodiment as illustrated in FIG. 1;

FIG. 3 is a schematic diagram illustrating the synthetic steps in preparing a layer-like structure with interspersed grafters and diluters, and the subsequent grafting of the polymer chains at the grafters as shown in FIG. 2;

FIGS. 4A and 4B show two generic chemical structures of the compositions in accordance with two embodiments of the present invention;

FIG. 5 shows the exemplified chemical structures of three compositions (#1, #2 and #3) in accordance with an embodiment of the present invention;

FIG. 6 shows the exemplified chemical structures of three grafter molecules (#G1, #G2 and #G3) in accordance with an embodiment of the present invention;

FIG. 7 shows the exemplified chemical structures of two diluter molecules (#D1 and #D2) in accordance with an embodiment of the present invention;

FIGS. 8A and 8B show the exemplified chemical reaction schemes for the synthesis of two composition (#3 and #4) in accordance with an embodiment of the present invention; and

FIG. 9 shows the tabulated results of the corresponding adhesion strength achievable by a number of the compositions in accordance with an embodiment of the present invention.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention relates to a composition for adhering one or more polymers to a substrate, particularly but not exclusively, for providing and/or enhancing adhesions between a polymer, for example poly(p-xylene) polymers such as Parylene, and a substrate for electrical and electronic applications. The composition can be used as an adhesive for adhering and/or enhancing bonding of one or more insulating polymers, such as for the purpose of providing heat and/or electric insulation, as well as moisture barriers. Preferably, the present invention can be used as an adhering intermediate layer for polymer insulation in through silicon vias (TSVs).

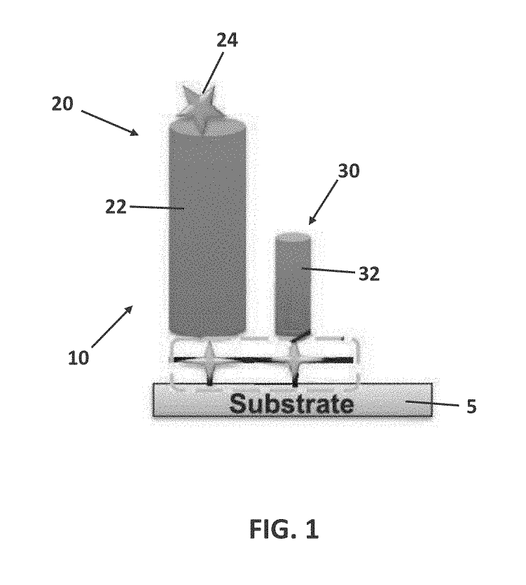

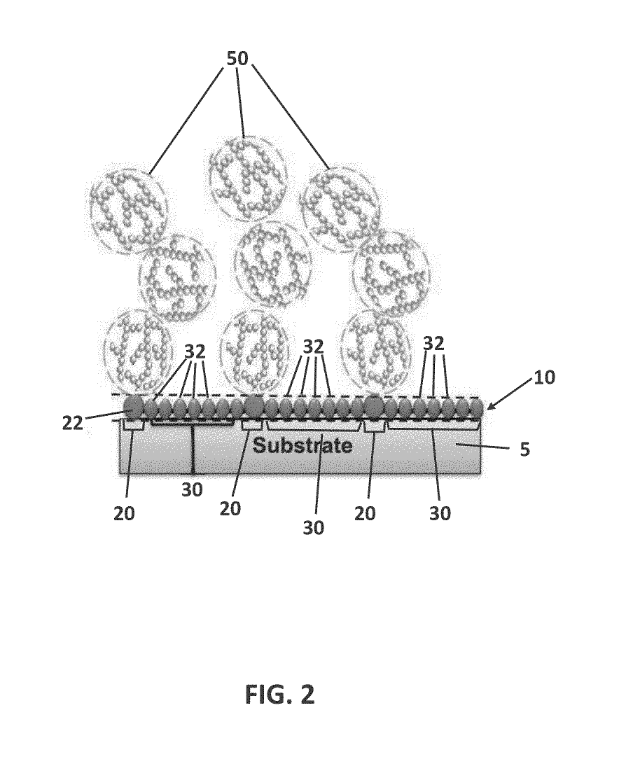

Referring to FIGS. 1 and 2, shown is an embodiment of the composition 10 comprising at least one first compound 20 and at least one second compound 30 adapted to be coated on a surface of a substrate 5 preferably in the form of a layer-like structure. Specifically, the tail groups of the first compound 20 and the second compound 30, such as but not limited to, Si—OR, are adapted to chemically bond among one another and with the substrate 5 via surface functional groups, such as but not limited to, surface hydroxyl groups on the substrate 5. Preferably, the composition 10 is provided in a substantially layer-like structure, and more preferably, a substantially monolayer-like structure.

The first compound 20 may comprise one or more first units 22, which are herein referred to as, for example, grafter molecules, grafter units, or grafters 22, with each of the grafters 22 comprising at least one functional group 24, such as but not limited to, one or more ethylenically unsaturated groups adapted to chemically react with one or more monomers via, for example, free radical chain-growth polymerization. The reaction or polymerization will result in the formation of one or more polymer molecules, which will, ideally, propagate into one or more fully-grown polymer chains 50 grafted at the respective sites of the grafters 22. Generally, the polymer chains 50 will then self-assemble into a plurality of repeated domain units at the substrate surface, which allow adhesion of the formed polymers to form a polymer coating at the substrate 5. In one specific embodiment, the monomers comprise para-xylylene (p-xylylene), and the formed polymers comprise Parylene.

The second compound 30 of the composition 10 may comprise one or more second units 32, which are herein referred to as, for example, diluter molecules, diluter units, or diluters 32. Particularly, the diluters 32 are arranged so as to be interspersed among the one or more grafters 22 in the layer-like composition 10, for example, as illustrated in FIG. 2. In contrast to the grafters 22, a structure of the diluters 32 does not comprises any functional head groups available for reacting with the monomers, i.e. no polymer chain can be grafted at the sites of the diluters 32. The diluters 32 may merely function to space apart the grafters 22 and thus, to space the grafted polymer chains 50 from one another. The presence and the interspersed arrangement of the diluters 32 among the grafters 22 assists in reducing concentration of the grafters 22 in the layer-like structure, thereby controlling, adjusting or optimizing the overall density of the grafted polymer chains 50 at the substrate surface.

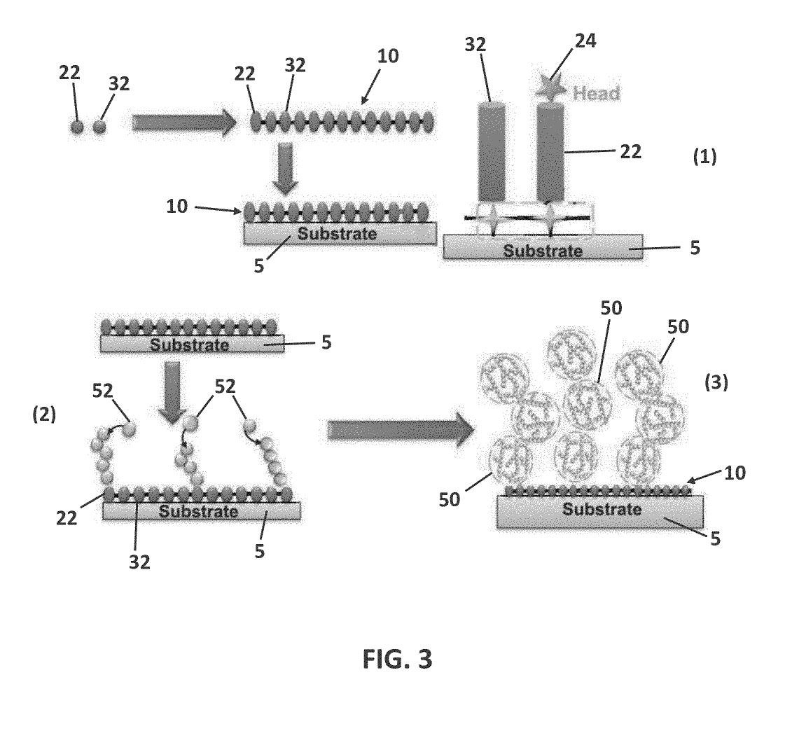

FIG. 3 is a schematic diagram showing (1) the preparation of the composition 10 with interspersed grafters 22 and diluters 32; (2) the polymerization of monomers 52 initiated at the reactive head groups 24 of the grafters 22 but not at the diluters 32, and the propagation of the monomers to become polymer chains 50; and (3) the subsequent self-assembly of the fully-grown polymer chains to form stable polymer domains on the substrate surface.

The interspersed arrangement of the diluters 32 among the grafters 22 is of particular significance in minimizing, reducing, or even preventing the chances of premature termination of the growing polymer molecules, which will result in defective polymer chains with inferior physical and chemical properties. For example, a highly dense grafter population may increase the possibility for reactive sites of one or more grafter molecules to be physically blocked by one or more growing polymer chains nearby. Additionally, the reactive head group of one grafter molecule may tend to react with an adjacent reactive head group of a neighboring grafter molecule, if the grafter density exceeds a certain, optimum level. This may effectively stop the grafters 22 from reacting with the monomers 52, and thus no polymer chains could be formed or at least polymer chain growth is compromised. Accordingly, the premature termination of polymer chains, as well as the blockage of the reactive groups due to overly high grafter density may result in defective polymer, which will adversely affect the interfacial bonding strength between the polymer and the substrate. In other words, the provision and the interspersed arrangement of the diluters 32 in the composition 10 optimize the polymerization condition of the monomers 52 and the growing polymer chains 50, and consequently, significantly enhance the chemical and mechanical stability of the adhesion at the polymer and substrate interface.

In one embodiment, a preferred grafter density can be achieved by having the composition 10 comprise the first compound 20 and the second compound 30, and thus the grafters 22 and the diluters 32, in a volume ratio of at least about 1:1, and more preferably, in a volume ratio of above 1, i.e. with more grafters 22 than the diluters 32 in volume, but always with the presence of diluters 32.

Although the diluters 32 are required to be non-reactive to the monomers 52 and thus unable to initiate a polymerization reaction, it is possible for the diluters 32 to interact non-chemically with the polymer chains grafted at the grafters 22. The non-chemical interaction can be, for example, electrostatic attractions, hydrophobic interactions, etc. as long as the interactions do not interfere with the chemical reactions between the grafters 22 and the monomers 52, as well as with the propagation of the polymer chains 50.

In another embodiment, the one or more grafters 22 and the one or more diluters 32 of the first compound 20 and the second compound 30, respectively, may each comprise one or more reactive tail groups that are adapted to chemically bond among one another and with the surface functional groups of the substrate to thereby bond the first and the second compounds 20, 30 at the surface of the substrate 5. For example, the grafters 22 and the diluters 32 may each comprise one or more hydroxyl functional groups capable of reacting with one or more respective surface hydroxyl groups at the substrate 5 to form one or more chemical bonds to securely adhere the layer-like composition 10 on the substrate 5. Preferably, the diluters 32 are of a smaller molecular size than the grafters 22, for example, as illustrated in FIG. 2, to thereby maximize the available surface areas for chemically bonding the diluters 32 with the substrate surface. This bonding strength at the interface of the layer-like composition 10 and the substrate 5 can therefore be customized, adjusted or optimized by controlling the respective concentration as well as molecular size of the grafter molecules 22 and the diluter molecules 32.

In one further embodiment, both the grafters 22 and the diluters 32 are preferred to be hydrophobic in nature by, for example, comprising one or more hydrophobic organic linkers such as, but not limited to, alkyl or alkyl derivative groups which prevent water from permeating to and hydrolyzing the chemical bonds at the adhesion interface.

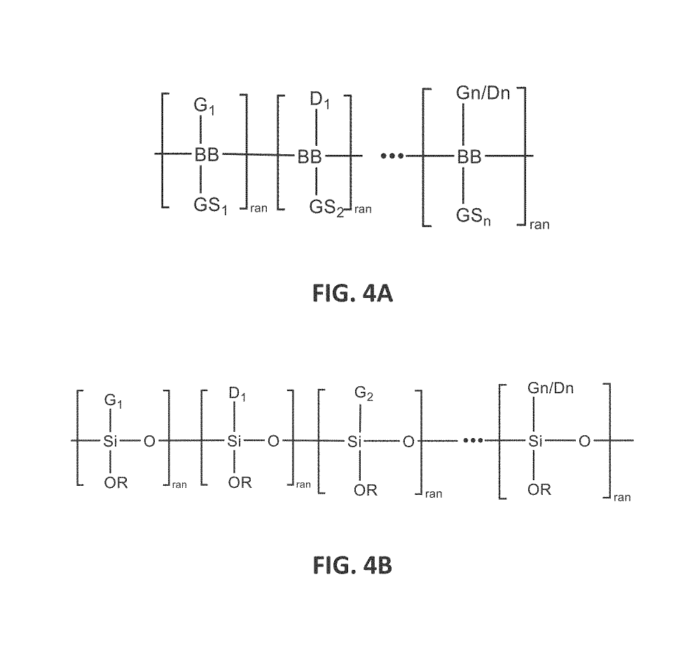

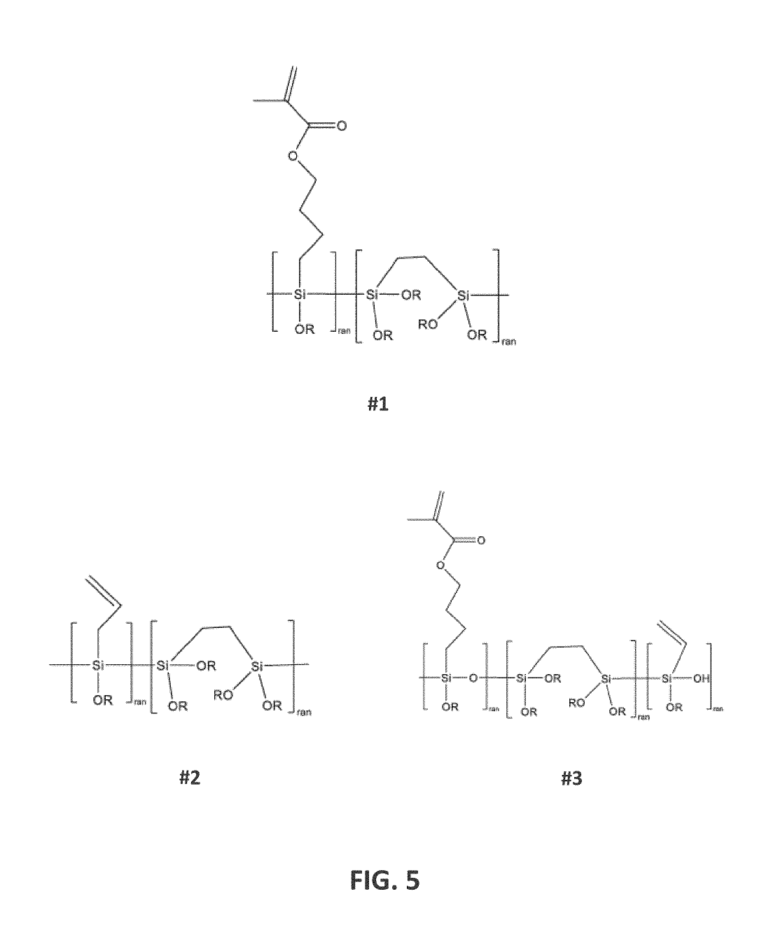

FIG. 4A shows a generic chemical structure of the composition 10 in accordance with an embodiment of the present invention. In this formula, “—B—B—” generally represents the backbone forming component of the repeating units of the composition 10, which can be, but is not limited to, “—Si—O—” for silane and silicone-type compositions, “—P—O—” for phosphate-type compositions, “C—C—O” for epoxy resin, “R′—NH—COO” for polyurethane and isocyanate-based composition, “C—C” for cyanoacrylate, “R′—CO—N—CO” for polyimide, and C—C═C—C for polybutadiene etc. “R′” is any group in which a carbon or hydrogen atom is attached to the rest of the molecule. “G₁” to “Gₙ” (n>=1) generally represent the functional head groups that are chemically reactive with monomers to form polymers, and the groups signify the corresponding repeating unit as being a grafter. “D₁” to “Dₙ” (n>=1) generally represent head groups that are not chemically reactive to monomers, and therefore unable to initiate any polymerization. These groups thus signify the corresponding repeating unit as being a diluter. “GS₁” to “GSₙ” generally represent functional tail groups that are adapted to chemically bond among one another and with the surface functional groups of the substrate to thereby adhere the composition layer with the substrate. FIG. 4B shows the exemplified generic structure of the composition 10, and in this example, the composition 10 comprises a “—Si—O—” silane backbone and functional tail groups represented by “OR”, with “R” being any alkyl or alkyl derivative groups. The chemical structure of the repeating units of a number of exemplified compositions are further illustrated in FIG. 5, i.e. (#1)—GA174+DBTES, which comprises one grafter and one diluter; (#2)—GVMS+DBTES, which comprises one grafter and one diluter; and (#3)—GA174+DBTES+GMS, which comprises two grafters and one diluter in their structures.

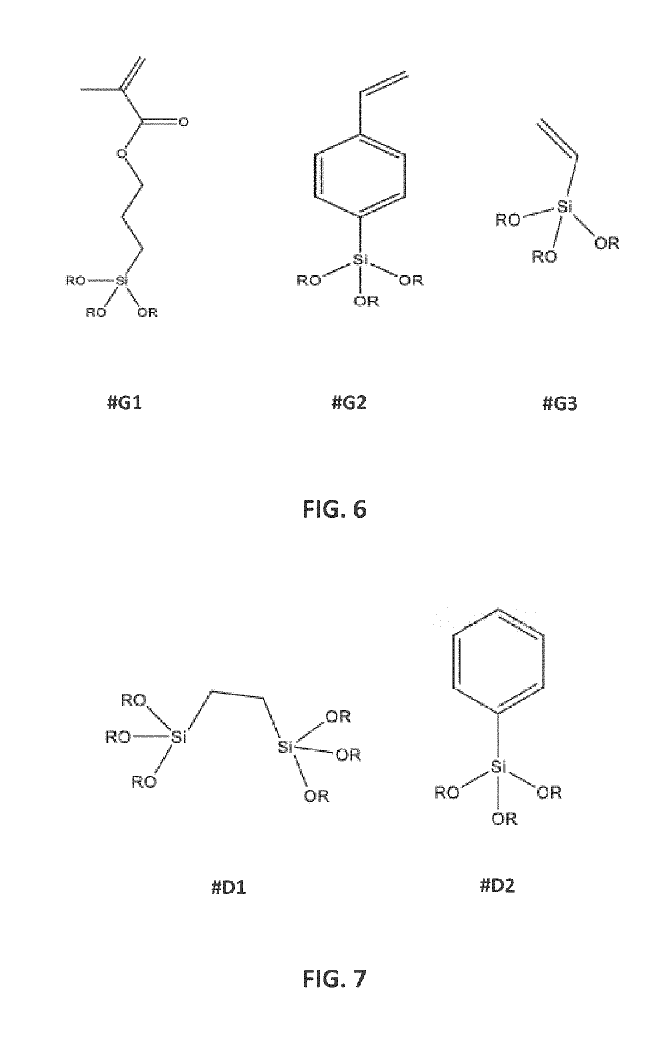

FIG. 6 illustrates the chemical structure of a number of exemplified grafters 22, namely, from left to right, (#G1) 3-(trimethoxysilyl) propyl methacrylate (GA174), (#G2) trimethoxy(4vinylphenyl) silane (GVPS) and (#G3) vinyltrimethoxy silane (GVMS). FIG. 7 further illustrates the chemical structure of a number of exemplified diluters 32, namely, from left to right, (#D1) 1,2-bis(triethoxysilyl)ethane (DBTES) and (#D2) phenyltrimethoxy silane (DPS).

Although various examples of the compositions, the grafters and the diluters have been described, the present invention shall not be restricted or limited to these specific embodiments. Instead, a person skilled in the art would appreciate that any possible variations and/or modifications to the embodied structures, as long as they are considered functionally and chemically reasonable and applicable without departing from the inventive concept of the present invention, shall also be encompassed.

The present invention also relates to a substrate 5 having an intermediate layer 10 on a surface thereof for adhesion of a polymer such as, but not limited to Parylene. Said intermediate layer 10 comprising one or more first surface bonding units, such as the grafters 22, interspersed with one or more second surface bonding units, such as the diluters 32, wherein only the one or more first surface bonding units are capable of chemically reacting with one or more monomers 52 to form polymers 50 to thereby adhere the polymers 50 at the substrate surface. In one specific embodiment, the intermediate layer 10 is of a thickness of about 0.4 nm to about 0.8 nm. Preferably, the intermediate layer 10 is of a substantially monolayer-like structure.

Without being restricted to the application on the adhesion of Parylene, most commonly known polymers may actually be potentially applicable to the present invention. A number of possible examples, especially for polymer dialectic materials for electronic applications such as TSV insulation, may include: benzocyclobutene (BCB)-based polymers, epoxy-based polymers such as SU-8, polyimide, epoxy, and silicone. Parylene, being a poly(p-xylylene) polymer, is adopted as an example to demonstrate the efficacy of the present invention due to its availability in the market, relatively low costs and low processing temperature, as well as its good moisture blocking and dielectric insulating properties.

The present invention further relates to a method of preparing a polymer coated surface on a substrate using the composition 10. The method comprises the step of providing a solution having at least one first compound 20 and at least one second compound 30, with the at least one first compound 20 comprising one or more grafters 22, and the at least one second compound 30 comprising one or more diluters 32.

The solution is prepared by dissolving the at least one first compound 20 and the at least one second compound 30 in a solvent. In one embodiment, the solvent may comprise at least one of an alcohol and water. Preferably, the alcohol comprises isopropyl alcohol and the solvent is prepared by mixing isopropyl alcohol and water in about 1:1 volume ratio. In one preferred embodiment, the at least one first compound 20 is provided at a volume ratio of about 0.5%-about 1.0% in respect of a total volume of the solution; and that the at least one second compound 30 is provided at a volume ratio of about 0.2%-about 1.0% in respect of a total volume of the solution.

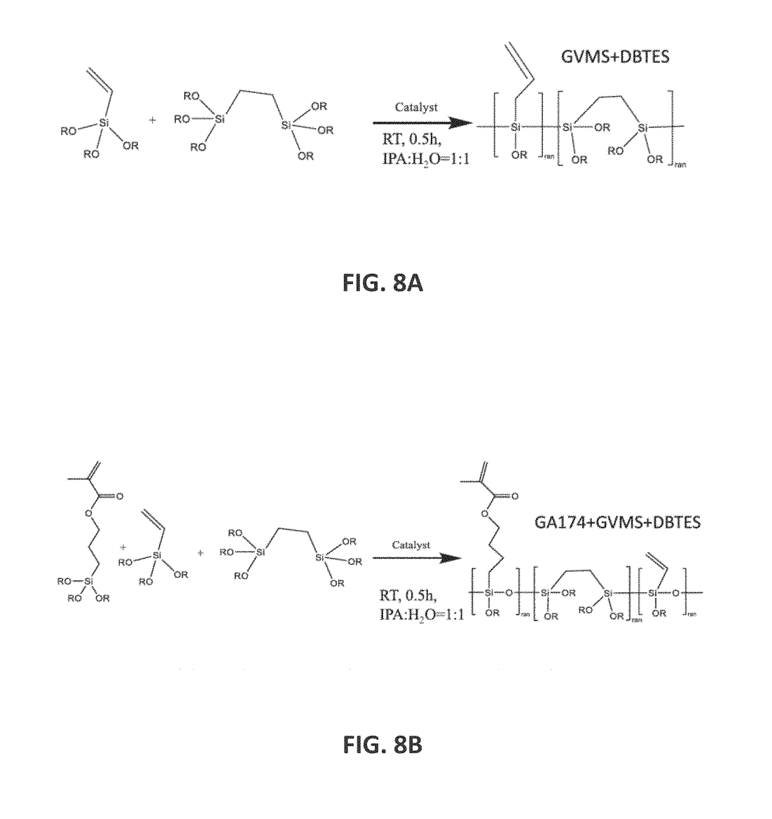

FIGS. 8A and 8B illustrate two exemplified reaction schemes showing the synthetic steps for the compositions #2—GVMS+DBTES and #3—GA174+GVMS+DBTES, with chemical structures being shown earlier in FIG. 5.

Specifically, after the solution is prepared, the surface to be coated will be immersed into said solution for about 10 min to about 30 min in ambient condition. After that the substrate will be removed from the solution, washed and be left for curing in ambient condition for over 8 hours to thereby allow the formation of a substantially layer-like coating of the composition 10 on the treated surface. As described earlier, the layer-like composition 10 comprises a plurality of grafters 22 and diluters 32 interspersingly arranged with one another, and more specifically, each of the grafters 22 and the diluters 32 comprises at least one reactive tail groups adapted to chemically bond among one another and with the surface functional groups of the substrate to thereby adhere the composition layer with the substrate.

The next step will be the reacting of the composition-coated surface with one or more monomers 52, such as p-xylylene, to thereby graft one or more Parylene polymers at the one or more grafter sites, but not at the one or more diluters 32. This reacting step can be conducted by any known polymerization or graft polymerization techniques, such as but not limited to, free radical chain-growth polymerization, for example, chemical vapor deposition (CVD) of Parylene. However, a person skilled in the art would understand that any other manner of polymerization technique such as but not limited to, bulk, solution, suspension, and/or emulsion polymerizations, and free radical chain-growth polymerization, ionic chain-growth polymerization, ring-opening polymerization and/or step-growth polymerization, may also be applicable.

To determine the adhesion strength provided by the composition 10, and particularly, whether the adhesion is sufficient to minimize, reduce or prevent interfacial delamination between the adhered Parylene layer and the substrate especially after the highly accelerated stress reliability test (HAST) conducted at 130° C., 85% relatively humidity and for 96 hours, a Tape Test is designed to quantify the degree of adhesion before and after the HAST. The steps of conducting the Tape Test are described as follows:

First of all, a sample substrate is treated under the HAST. After the HAST, the sample substrate adhered with a Parylene layer using the composition 10 in accordance with an embodiment of the present invention is marked by surface cutting the Parylene layer into an array of 10×10 squares, each having an area of about 1 mm². The number of the undamaged film squares after the cutting are counted (i.e. the first count).

The surface of the Parylene array is attached with a piece of adhesive tape, followed by a manual pulling off of the tape from the Parylene layer. The number of any undamaged film squares in the array, i.e. squares of the undamaged Parylene layer, are counted again (i.e. the second count).

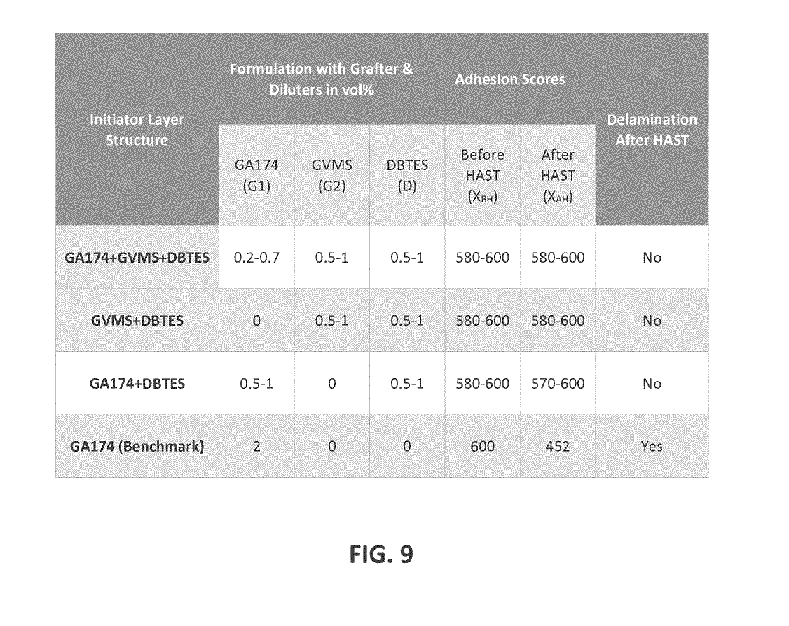

These taping, pulling, and counting steps are repeated up to 4 more times (i.e. the third to the sixth counts). Results of all the six counts are summed up to provide a score of X_{AH}, as presented in the table of FIG. 9.

A number of experiments with the respective Parylene layer being adhered to the substrate using different compositions 10 prepared under different grafter-to-diluter ratios—see the table of FIG. 9—have been conducted for comparison. In addition, corresponding control experiments which have been prepared and conducted under the same conditions but without the HAST treatment, have also been prepared and studied under the Tape Test, with the scores X_{BH} being recorded in the table of FIG. 9.

It is confirmed by scanning electron microscopy (SEM) that samples with scores above 550 out of 600 demonstrate no interfacial delamination. The score of 550 is thus used as a benchmark in assessing any potential interfacial delaminations.

The Tape Test results as shown in the table of FIG. 9 reveal that the presence of diluters in the composition, which is DBTES in this experiment, significantly enhances the interfacial adhesion between the Parylene layer and the substrate. Specifically, all of the samples being tested with diluters in the composition have achieved a test score of above 550/600 after HAST, which demonstrated a significant improvement in adhesion strength from those prepared without diluters, e.g. the sample with only grafter GA174 in the composition is found to have a test score of 452/600 after HAST.

The invention is advantageous in that it provides a composition for adhering a polymer to a substrate, and particularly, for providing and/or enhancing adhesions between a polymer and a substrate for electrical and electronic applications. For example, the composition of the present invention can be applied to adhere and/or to enhance adhesion of one or more insulating polymers, such as Parylene, with an electrically conducting surface such as, but not limited to, one or more silicon substrates of a through silicon via (TSV). The composition can be provided in the form of, for example, a layer-like structure adapted to chemically bond with a surface of the substrate. The composition comprises at least one first compound having one or more grafter units, with each of the grafters having at least one reactive functional head group adapted to chemically react with one or more monomers in forming the polymer. Particularly, the polymerization will result in one or more polymer molecules grafted at the respective grafter sites to thereby adhere the formed polymer chains at the substrate surface. More importantly, the composition also comprises at least one second compound having one or more diluter units, which are arranged to intersperse among the one or more grafters in the layer-like structure causing a reduction and thus, optimization of the grafter density at the layer-like structure. In contrast to the grafters, the diluters do not comprise reactive functional head groups for polymerization, and therefore, are not capable of chemically reacting with the monomers. No polymer chains can thus be grafted at the sites of the diluters. The invention is shown to allow optimization of the grafter density in the layer-like adhesive structure, and consequently, minimize, reduce or avoid chances of premature termination of the growing polymer chains. The invention is thus capable of significantly enhancing the interfacial bonding strength between the polymer and the substrate, and is found to be effective in minimizing, reducing, or avoiding interfacial delamination under the highly accelerated stress test (HAST).

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims hereof, any element expressed as a means for performing a specified function is intended to encompass any way of performing that function. The invention as defined by such claims resides in the fact that the functionalities provided by the various recited means are combined and brought together in the manner which the claims call for. It is thus regarded that any means that can provide those functionalities are equivalent to those shown herein.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A composition for adhering one or more polymers to a substrate, the composition comprising:
at least one first compound adapted to be coated on a surface of the substrate, the first compound comprising one or more first units each having at least one functional group adapted to chemically react with at least one monomer to form the one or more polymers; and
at least one second compound adapted to be coated on the surface of the substrate, the second compound comprising one or more second units interspersed among the one or more first units of the first compound, wherein each of the one or more second units is not chemically reactive to the at least one monomer.

2. The composition according to claim 1, wherein the one or more first units of the first compound and the one or more second units of the second compound are adapted to be chemically bonded with one or more surface functional groups of the substrate.

3. The composition according to claim 1, wherein the at least one first compound and the at least one second compound are in a volume ratio of at least about 1:1.

4. The composition according to claim 1, wherein the at least one first compound comprises one or more of 3-(trialkyloxysilyl)propyl methacrylate, vinyltrialkyloxysilane and trialkyloxy(4-vinylphenyl)silane.

5. The composition according to claim 1, wherein the at least one second compound comprises one or more of 1,2-Bis(trialkyloxysilyl)ethane, phenyltrialkyloxysilane, trialkyloxy(ethyl)silane, and alkyloxymethylsilane.

6. The composition according to claim 1, wherein the one or more polymers are formed from polymerization of a plurality of the monomers grafted at the one or more first units.

7. The composition according to claim 1, wherein the one or more second units are of smaller molecular size than the one or more first units.

8. The composition according to claim 1, wherein the composition is a substantially of a layer like structure.

9. A method of preparing a polymer coated surface on a substrate using the composition of claim 1, comprising steps of:
providing a solution having at least one first compound and at least one second compound, the at least one first compound comprising one or more first units, and the at least one second compound comprising one or more second units;
treating a surface of a substrate with the solution thereby forming a treated surface bonded with the one or more first units and the one or more second units, with the one or more first units and the one or more second units being interspersed with one another;
reacting the treated surface with one or more monomers thereby grafting one or more polymers only at the one or more first units, but not at the one or more second units.

10. The method according to claim 9, wherein the step of providing a solution having at least one first compound and at least one second compound comprises dissolving the at least one first compound and the at least one second compound in a solvent.

11. The method according to claim 10, wherein the solvent comprises at least one of an alcohol and water in about 1:1 volume ratio.

12. The method according to claim 9, wherein the at least one first compound is provided at a volume ratio of about 0.5%-about 1.0% in respect of a total volume of the solution.

13. The method according to claim 9, wherein the at least one second compound is provided at a volume ratio of about 0.2%-about 1.0% in respect of a total volume of the solution.

14. The method according to claim 9, wherein the step of forming a treated surface bonded with the one or more first units and the one or more second units interspersed with one another comprises forming chemical bonds between the respective one or more first units and one or more second units and with one or more surface functional groups of the substrate surface.

15. The method according to claim 9, wherein the step of treating a surface with the solution comprises immersing the surface in the solution for about 10 min to about 30 min in ambient condition, removing the surface from the solution, washing the surface, and then curing the surface for over 8 hours in ambient condition to form the treated surface.

16. The method according to claim 9, wherein the step of reacting the treated surface with one or more monomers comprises depositing of a vapor comprising the one or more monomers onto the treated surface.

17. A substrate having an intermediate layer on a surface thereof for adhesion of a polymer, said intermediate layer comprising one or more first surface bonding units interspersed with one or more second surface bonding units, wherein only the one or more first surface bonding units are capable of chemically reacting with one or more monomers to form polymers to thereby adhere the polymers at the substrate surface.

18. The substrate according to claim 17, wherein the intermediate layer is of a thickness of about 0.4 nm to about 0.8 nm.

19. The substrate according to claim 17, wherein the intermediate layer is of a substantially monolayer-like structure.
